(19) United States
(12) Patent Application Publication
(10) Pub. No.: US 2015/0111186 A1
(43) Pub. Date: Apr. 23, 2015

(54) TOOL FOR PHYSICAL AND MENTAL TRAINING

(71) Applicant: Marco Meucci, Piombino (Livomo) (IT)

(72) Inventor: Marco Meucci, Piombino (Livomo) (IT)

(21) Appl. No.: 14/399,774

(22) PCT Filed: Feb. 20, 2013
(86) PCT No.: PCT/IB2013/051384

§ 371 Date: Nov. 7, 2014

(30) Foreign Application Priority Data
May 8, 2012 (IT) TO2012U000083

(51) Int. Cl. G09B 19/00

(52) U.S. Cl. CPC G09B 19/00
USPC 434/236

(57) ABSTRACT

A tool for physical and mental training, includes a central body to which a plurality of peripheral bodies of variable characteristics are connected via slidable connection rods in such a way that the distance between the individual components, and hence the structure of the tool itself, are variable at will.

### CROSS REFERENCE TO RELATED APPLICATIONS

This application is a national stage of PCT International Application No. PCT 820131051384, tiled on Feb. 20, 2013, and published in English on Nov. 14, 2013, as WO 2013168009 A1. which claims priority to Italian Utility Model Application No. T02012U000083 filed on May 8, 2012, the entire disclosures of which are incorporated herein by reference.

The present invention relates to a tool for physical and mental training, characterized by a structure that can be assembled and transformed according to the type of training that it is desired to perform,

In particular, the tool forming the subject of the present disclosure can be used in the field of training and in the physiotherapy sector by performing various exercises that stimulate the neuromuscular system developing coordination and psychomotor capacities,.

The claims form an integral part of the technical teaching provided herein in relation to the invention.

The invention will now be described, purely by way of non-limiting example, with reference to the annexed representations, wherein:

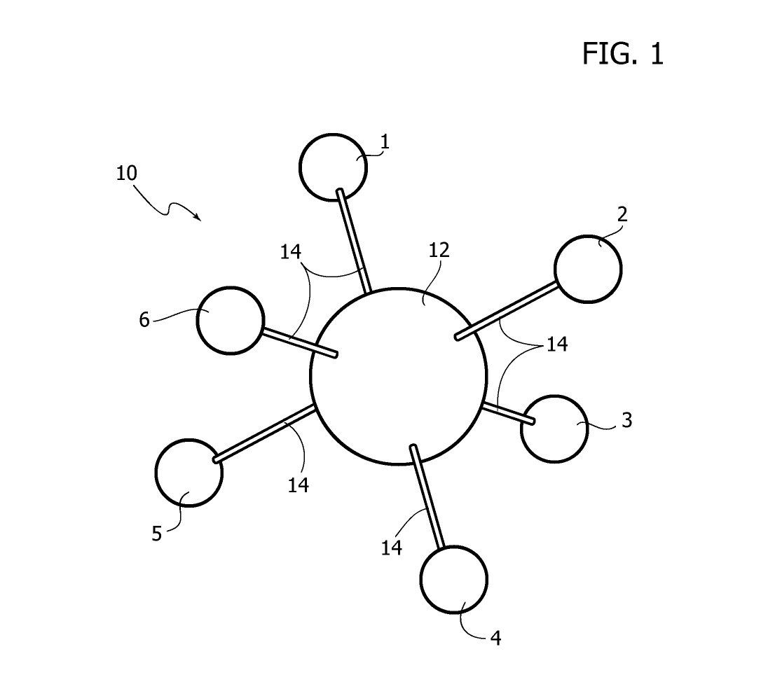

FIG. 1 is a schematic perspective view of an embodiment of the tool described herein;

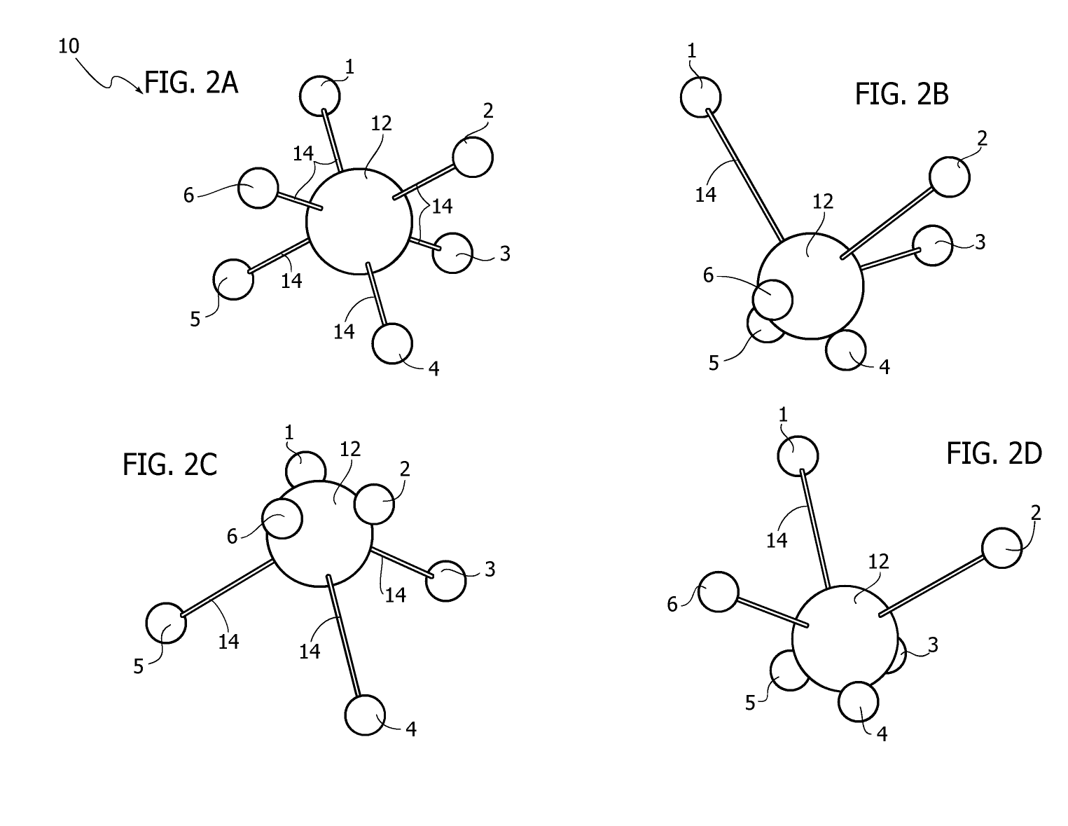

FIGS. 2A to 2D illustrate some functional configurations that can be assumed by the tool of FIG. 1;

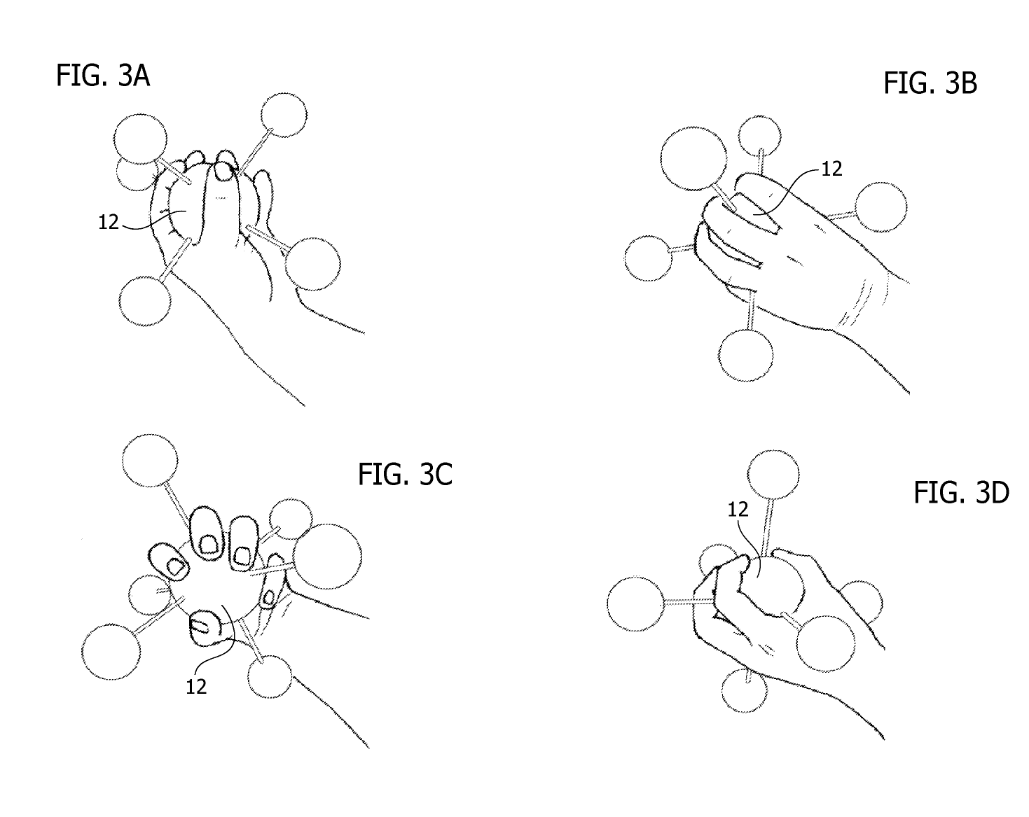

FIGS. 3A to 3D illustrate, according to different views, an example of how the tool of FIG. 1 can be gripped;

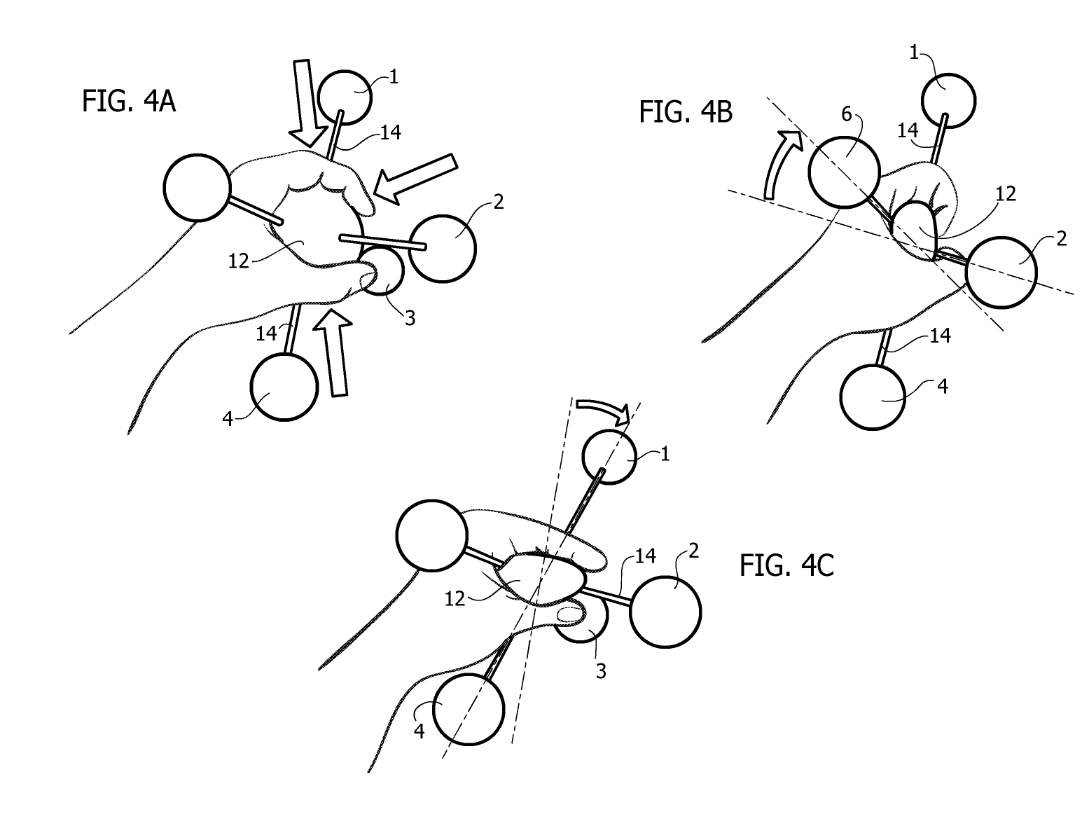

FIGS. 4A to 4C illustrate a first type of exercise conceived to improve hand grip strength and motor control, that can be carried out with the tool of FIG. 1;

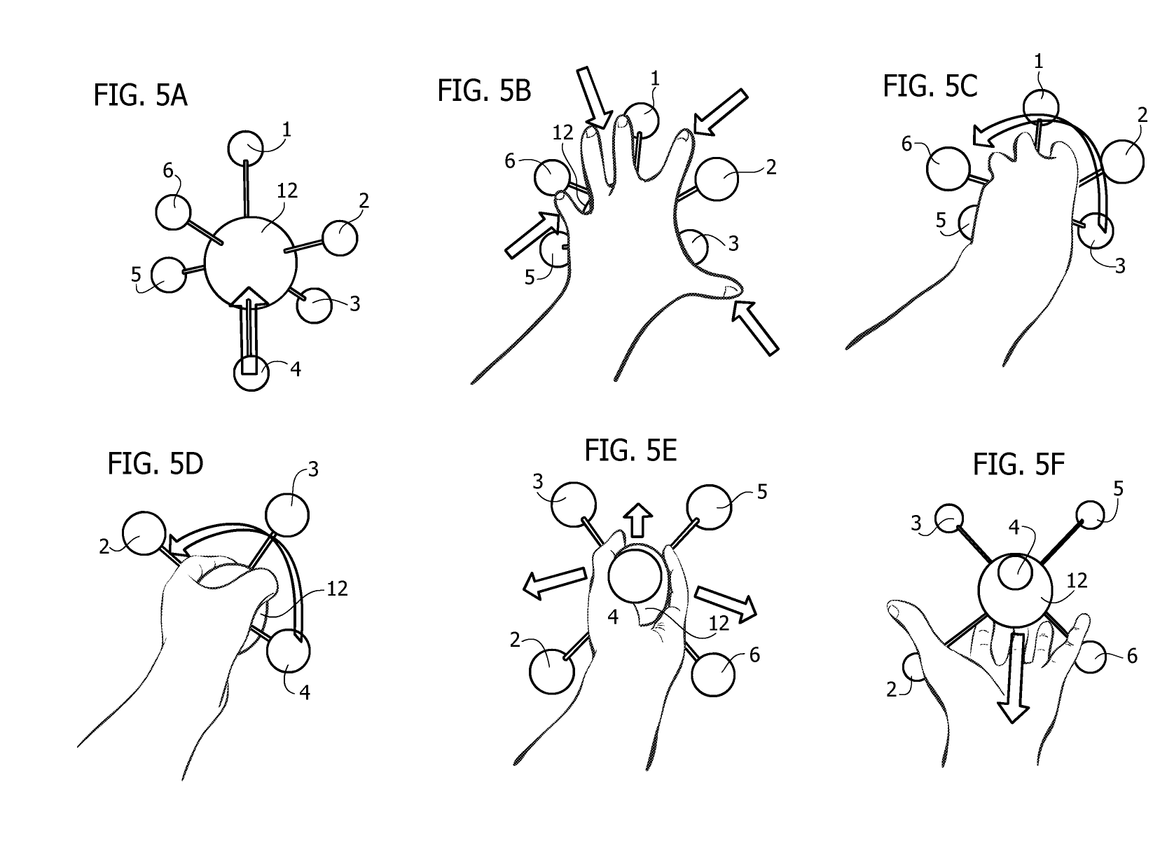

FIGS. 5A to 5F illustrate a second type of exercise conceived to improve wrist and/or forearm mobility, that can be carried out with the tool of FIG. 1: and

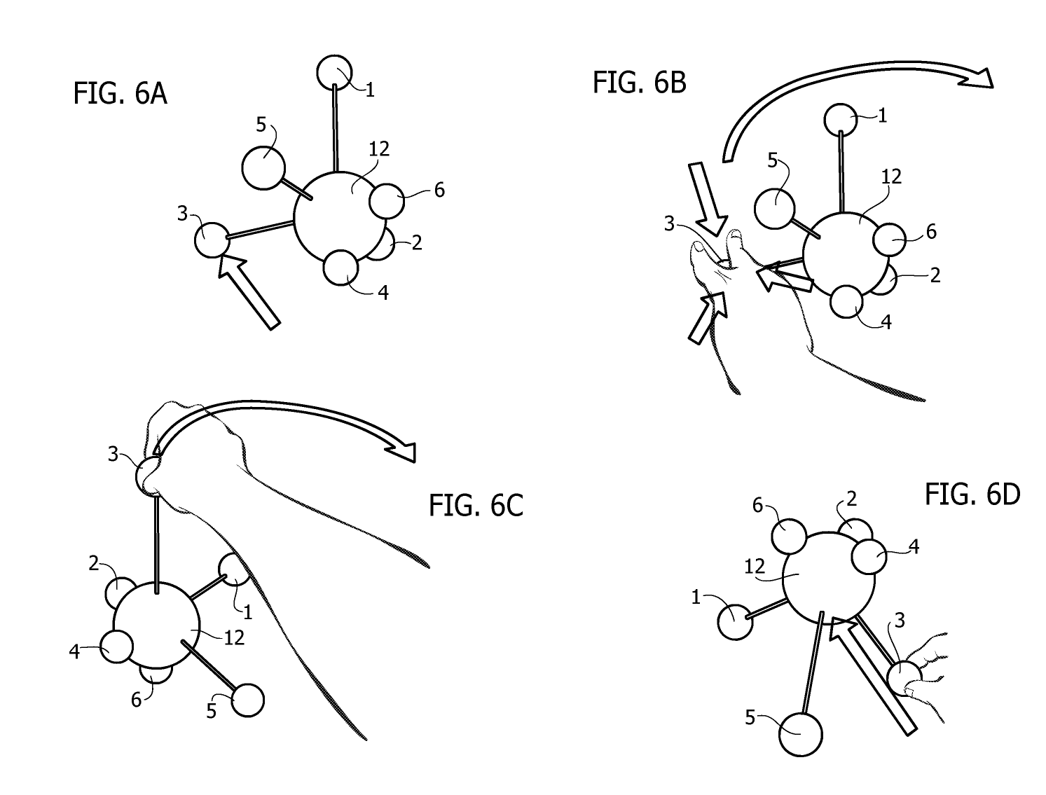

FIGS. 6A to 6D illustrate a third type of exercise conceived to improve the mobility of the shoulder, that can be carried out with the tool of FIG. 2B.

In the ensuing description various specific details are illustrated, aimed at an in-depth understanding of the embodiments. The embodiments may be provided without one or more of the specific details, or with other methods, components, materials, etc. In other cases, known structures, materials, or operations are not shown or described in detail so that various aspects of the embodiment will not be obscured.

The references used herein are provided only for convenience and hence do not define the scope of protection or the scope of the embodiments.

The tool forming the subject of the present disclosure comprises a structure that resembles an atom-like structure. In particular, said tool comprises a central body or core 12, to which a plurality of peripheral bodies 1-6 are connected via connection rods or bars 14. Said connection is such that the distance between the peripheral bodies and the central body can be varied at will.

In particularly preferred embodiments, as in the one illustrated, each individual connection rod traverses in a substantially diametral plane the central body, projecting therefrom in opposite radial directions. Removably mounted on each of the two opposite ends of the connection rod is a peripheral body. The rod is mounted on the central body via a friction fit between its outer surface and the surface provided by the passage of the central body that it traverses. Said type of fit has a dual function; in the first place, it enables fixing in position of the rod with respect to the central body in order to enable normal use of the tool, and in the second place, it enables adjustment of the position of the rod, enabling it to slide through the central body varying the overall configuration of the tool according to the exercise that is to be performed. In preferred embodiments, the central body and the peripheral bodies are constituted by a rubber-based material, whereas the rods are made of a rigid plastic material.

In the preferred embodiment illustrated in the figures, the connection rods are three in number, perpendicular to one another, and the peripheral bodies connected thereto are SIX in all. The total number of connection rods and of peripheral bodies, as well as their arrangement and orientation, may in any way vary according to the requirements of usc. In addition, the connection rods nay all have one and the same length or else different lengths and have graduation marks, to the nearest millimetres, to adjust the positioning of the same towards the central sphere. Likewise, the peripheral bodies may all have one and the same shape and/or size and/or weight and/or consistency, or else be different from one another. In various embodiments, the peripheral bodies may have different colours and/or bear different marks, designed, to distinguish one peripheral body from another and enable execution of multiple exercises. In this connection, it should be noted that in general—this depending obviously upon the type of exercise the more the peripheral bodies differ from one another as, regards their constitution (shape, weight, size, colour, consistency,; etc,), the more the tool is able: to stimulate the coordinative and conditional capacities of the user.

In various embodiments, the central body has a shape and size such that it can be gripped, In various particularly preferred embodiments, the central body has a consistency such that it can be deformed, for example squeezed or compressed, with just one hand, in various embodiments, the central body may have various shapes and/or dimensions and/or weight and/or colours and/or consistency and/or bear different marks.

In various embodiments, the peripheral bodies are smaller than the central body and have the function of identifying specific positions in space around the central body. The connection rods, are slidable and on be oriented within the central body so as to enable variation of the distance between the peripheral bodies and the central body and/or between the various peripheral bodies.

Illustrated hereinafter are some examples of exercises that can be performed via the tool described above.

The user can grip the central body in a wide range of ways according to the type of exercise that it is desired to perform and to the functionality of the upper limb. For example, with reference to FIGS. 3, it is possible to grip the central body in such a way that one rod is positioned between the thumb and the index finger, another between the index, finger and the middle finger, and the last between the ring finger and the little finger. It should be noted that the regularity and symmetry of the tool in this basic form enables the user to grip it on any side and whatever its position.

A first exercise may, for example, consist in gripping and compressing the central body, with the same hand that holds it in chosen geometrical planes in order to stimulate specific groups of muscles of the hand. When carrying out this exercise, the deformation of the central body moves the connection rods and changes the positions of the peripheral bodies, enabling the user to control and correct his own movements. The positions of the various components will, in fact, vary according to the directions in which the hand exerts an action of compression on the central body. In this connection. FIGS. 4B and 4C illustrate two different actions of compression exerted on the central body, starting from the condition of FIG. 4A. In FIG. 4B, the action is in a plane substantially orthogonal to the palm of the hand, whereas in FIG. 4C, the action is in a plane substantially parallel to the palm of the hand. The action of FIG. 4B is controlled following the corresponding displacement of the peripheral body 6, whereas the action of FIG. 4C is controlled following the corresponding displacement of the peripheral body 1.

A second type of exercise may, instead, consist in varying the orientation of the tool with respect to a resting plane in which it lies, via rotation of the wrist or of the entire arm corresponding to the hand that grips the central body (see the sequence of FIGS. 5A to 5F). In this exercise, the peculiarity of the individual peripheral bodies and of the central body (shapes, colours, symbols, dimensions, etc.) constitute the references of the user for carrying out the exercise and verify proper execution thereof.

Thanks to the slidable connection between the rods and the central body, the tool can assume a wide range of configurations amongst which the ones illustrated by way of example in FIGS. 2A-2D, for carrying out multiple exercises.

In the configuration illustrated in FIG. 2B, in which all the rods are pulled upwards with respect to the central body, it is possible to carry out an exercise in which, with reference to FIG. 6, the tool is resting on a surface via the peripheral bodies 2, 3 and 4 and, by moving the peripheral body 3, this is turned upside down via an ample movement of the arm, along an are of a circle. The rod to which said peripheral body is associated is used as a sort of lever of which the peripheral body 6, which rests on the surface, constitutes the fulcrum of rotation. As illustrated in the sequence of FIGS. 6A-6D, said rod is basically displaced from a first position lying on the surface to a second upright position using the hand opposite to the peripheral body 3. It is possible from here to return to the starting conditions combining at this point the exercise described in FIG. 5 and enabling the user to perform a continuous exercise without any interruption. In Fact, by gripping the tool from beneath with the same hand, it can be rotated in suspension, as described by the sequence 5B-5F carried out in reverse order (starting from the position 5F and terminating with the position 5B). This will make it possible to return into the starting position, symmetrical to the starting position 6A, and start again the entire sequence with the other arm.

Thanks to the distinction between and/or characterization of the individual peripheral bodies, it is possible to perform exercises that envisage interaction with said bodies according to a specific order so as to facilitate or instead, complicate the exercise in order to stimulate the psychomotor capacities of the user. For example, by touching, gripping, squeezing or moving the peripheral bodies according to a preset order, following their numbering or their respective colours, it is possible to propose exercises for mental training, stimulating the memory or logical faculties.

The tool forming the subject of the present disclosure thus makes it possible to perform innumerable exercises, from very simple to increasingly complex ones. It is, in fact, possible to combine the exercises described previously, and others not presented in this document, to increase the difficulty, complexity, and variability of the exercises.

It is moreover possible to envisage a series of accessories in association with the tool, having the function of modifying the configuration thereof, such as, for example, extensions of the rods, rods of a wide range of lengths, peripheral bodies and central bodies of multiple shapes, weights, dimensions, consistency, etc.

From the above description, it is evident that the tool described herein constitutes a simple and versatile tool that enables stimulation both of the motor capacities and of the mental capacities of the person.

Of course, without prejudice to the principle of the invention, the details of construction and the embodiments may vary, even significantly, with respect, to what has been Illustrated herein purely by way of non-limiting example, without thereby departing from the scope of the invention, as defined by the annexed claims.

1. A tool for physical and mental training, comprising a central body to which a plurality of peripheral bodies are connected via connection rods, in such a way that the distance between the peripheral bodies and the central body is variable at will.

2. The tool according to claim 1, wherein each individual connection rod of the connection rods traverses in a substantially diametral plane the central body, projecting therefrom in opposite radial directions, and wherein removably mounted on each of the two opposite ends of the connection rod is a peripheral body.

3. The tool according to claim 1, wherein said rods are mounted on the central body via a friction fit between outer surfaces of said rods and a respective passage of the central body that said rods traverse.

4. The tool according to claim 1, wherein the central body has a shape and size such that the central body can be gripped.

5. The tool according to claim 1, wherein the central body has a consistency such that the central body is deformable with just one hand.

6. The tool according to claim 1, wherein the peripheral bodies are smaller than the central body and have the function of identifying specific positions in space around the central body.

7. The tool according to claim 1, wherein said central body and/or said peripheral bodies have a spherical shape.

8. The tool according to claim 1, wherein the connection rods are preferably approximately 35 cm in length, and are slidable and orientable within the central body so as to enable variation of the distance and position between the peripheral bodies and the central body and/or between the various peripheral bodies.

9. The tool according to claim 1, wherein said central body and various peripheral bodies are made of a rubber-based material, whereas said rods are made of a rigid plastic material.

10. The tool according to claim 1, wherein the peripheral bodies may have different colours and/or shapes and/or weight and/or consistency and/or roughness and be made of different materials and/or present different symbols on the surface, designed to distinguish one peripheral body from another.

11. The tool according to claim 1, wherein said central body may have a different colour and/or shape and/or weight and/or consistency and/or roughness and be made of different materials and/or present different symbols on the surface for carrying out multiple exercises.

12. The tool according to claim 1, further comprising a series of accessories, amongst which extensions of the rods, rods of various lengths, peripheral bodies and central bodies of different shape, weight, appearance, consistency, and size.

13. The tool according to claim 5 wherein the central body is squeezable or compressible by the one hand.

14. The tool of claim 7, wherein the central body has a diameter of 6 cm and/or the peripherial bodies have a diameter of 4 cm.
